(19) United States
(12) Patent Application Publication
(10) Pub. No.: US 2026/0120080 A1
(43) Pub. Date: Apr. 30, 2026

(54) METHODS FOR MANAGING REAL ESTATE BLOCKCHAIN INFRASTRUCTURE AND SYSTEMS THEREOF

(71) Applicant: Jones Lang LaSalle IP, Inc., Chicago, IL (US)

(72) Inventors: Devank GUPTA, Bangalore (IN); Pavankumar MANVI, Bangalore (IN); Prasanta KUMAR PRUSTY, Hyderabad (IN); Ranjeet KUMAR, Bangalore (IN); Shijo MATHEW, Bangalore (IN)

(21) Appl. No.: 18/409,294

(22) Filed: Jan. 10, 2024

(51) Int. Cl. G06Q 50/16; G06Q 20/36; G06Q 20/38; G06Q 20/40

(52) U.S. Cl. CPC G06Q 20/36; G06Q 20/363; G06Q 20/382; G06Q 20/389; G06Q 20/4014; G06Q 50/16; G06Q 50/167

(57) ABSTRACT

Methods, non-transitory computer readable media, and property transaction systems are disclosed that generate on a blockchain network a smart contract after receiving authorization data from a seller client device and including a seller wallet ID. A buyer is authenticated in response to a request to obtain rights in the property received from a buyer client device via a GUI. The GUI comprises listing data received from the seller client device and the request comprises a buyer wallet ID. The blockchain network is queried to determine that a transaction amount was credited to the seller wallet ID from the buyer wallet ID. The seller wallet ID is provided to the buyer client device in response to the request. The buyer wallet ID is provided to the smart contract to cause a transfer of an NFT for the property to the buyer wallet ID.

### FIELD

This technology generally relates to blockchain network transactions and, more particularly, to managing blockchain infrastructure to facilitate real estate transactions.

### BACKGROUND

Real estate transactions (e.g., leases, rentals, financing or fractional ownership, and purchases) currently involve a significant amount of documentation, some portion of which is often recorded in government repositories. For example, property deeds can be maintained by government agencies and searched by the public to analyze a property chain of title. Documentation generation, execution, and management generally introduces significant delay in the transfer of property rights from one party to a property transaction to another party.

The documentation associated with real estate transactions may be in a physical or paper form or may be digitized and searchable via a database.

Unfortunately, these real estate transaction recordation methods have limited transparency and are therefore relatively susceptible to fraud. Moreover, these property recordation techniques are cumbersome and inefficient.

Increasingly, government agencies are recording property records on blockchain networks. While property records on blockchain networks increases transparency and reduces fraudulent activity, there is currently no way to efficiently execute transactions against real estate within blockchain networks. While documentation can be recorded on blockchains subsequent to closed real estate transactions, there is no secure and efficient way to conduct a real estate transaction natively within a blockchain network.

### SUMMARY

In one example, a method for managing real estate blockchain infrastructure is disclosed that is implemented by a property transaction system and includes generating on a first blockchain network a smart contract configured to transfer ownership of a non-fungible token (NFT) for a property. The smart contract is generated after receipt of authorization data from a first client device of a seller and including a first wallet identifier (ID) for the seller. A buyer is then authenticated in response to a request to obtain rights in the property received from a second client device of the buyer via a provided graphical user interface (GUI), The GUI comprises listing data received from the first client device and the request comprises a second wallet ID for the buyer. A second blockchain network is queried to determine that a transaction amount was credited to the first wallet ID from the second wallet ID. The first wallet ID is provided to the second client device in response to the request. The second wallet ID is provided to the smart contract to cause a transfer of the NFT to the second wallet ID and recordation of an ownership transfer of the property on the first blockchain network.

In another example, a property transaction system is disclosed that includes memory including instructions stored thereon and one or more processors configured to execute the stored instructions to generate on a first blockchain network a smart contract configured to transfer ownership of an NFT for a property. The smart contract is generated after receipt of authorization data from a first client device of a seller and including a first wallet ID for the seller. A buyer is then authenticated in response to a request to obtain rights in the property received from a second client device of the buyer via a provided GUI, The GUI comprises listing data received from the first client device and the request comprises a second wallet ID for the buyer. A second blockchain network is queried to determine that a transaction amount was credited to the first wallet ID from the second wallet ID. The first wallet ID is provided to the second client device in response to the request. The second wallet ID is provided to the smart contract to cause a transfer of the NFT to the second wallet ID and recordation of an ownership transfer of the property on the first blockchain network.

In yet another example, a non-transitory computer readable media is disclosed that has instructions for managing real estate blockchain infrastructure stored thereon and includes executable code that, when executed by one or more processors, causes the processors to generate on a first blockchain network a smart contract configured to transfer ownership of an NFT for a property. The smart contract is generated after receipt of authorization data from a first client device of a seller and including a first wallet ID for the seller. A buyer is then authenticated in response to a request to obtain rights in the property received from a second client device of the buyer via a provided GUI, The GUI comprises listing data received from the first client device and the request comprises a second wallet ID for the buyer. A second blockchain network is queried to determine that a transaction amount was credited to the first wallet ID from the second wallet ID. The first wallet ID is provided to the second client device in response to the request. The second wallet ID is provided to the smart contract to cause a transfer of the NFT to the second wallet ID and recordation of an ownership transfer of the property on the first blockchain network.

This technology provides several advantages including methods, non-transitory computer readable media, and property transaction systems that interface with maps platform server APIs to generate peak or rush hour commute time and emissions data based on obtained employee locations and prospective and current office locations. Thus, the property transaction systems of this technology process a large amount of data for enterprises and present the resulting analytics via improved GUIs with arrangements of interactive graphs, charts, rankings, heat maps, and other visualizations to inform relocation decisions.

### BRIEF DESCRIPTION OF THE DRAWINGS

FIG. 1 is a block diagram of an exemplary network environment with a property transaction system;

FIG. 2 is a block diagram of an exemplary property transaction system;

FIG. 3 is a flowchart of an exemplary method for managing real estate blockchain infrastructure;

FIG. 4 is a screenshot of an exemplary property listing interface for a plurality of properties offered for sale;

FIG. 5 is a screenshot of an exemplary property purchase interface for a particular property;

FIG. 6 is a screenshot of an exemplary authentication overlay;

FIG. 7 is a screenshot of an exemplary seller wallet overlay;

FIG. 8 is a screenshot of an exemplary transaction success overlay; and

FIG. 9 is a screenshot of an exemplary blockchain transaction detail interface.

### DETAILED DESCRIPTION

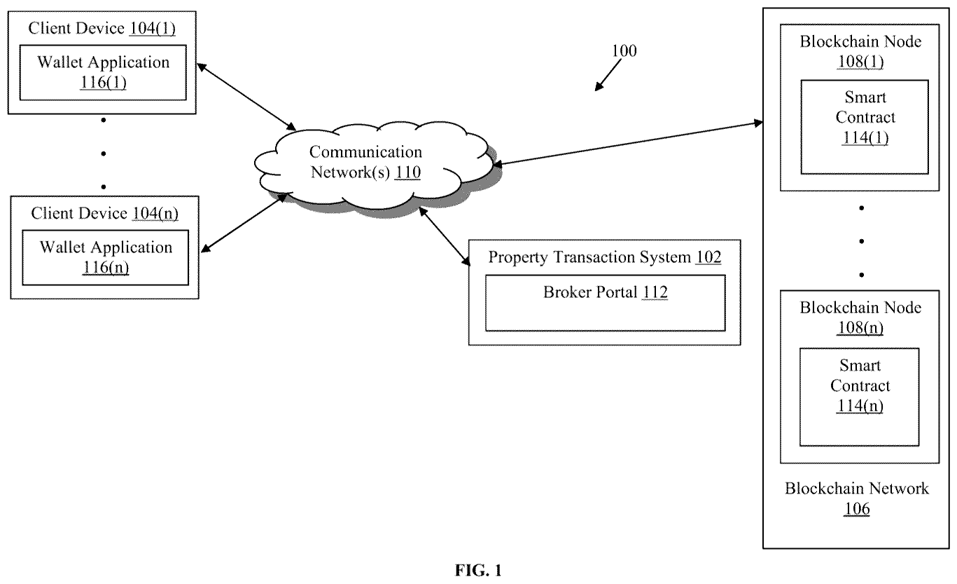

Referring to FIG. 1, an exemplary network environment 100 is illustrated that includes a property transaction system 102 coupled to client devices 104(1)-104(n) and a blockchain network 106 with blockchain nodes 108(1)-108(n) via communication network(s) 110. The network environment 100 may include other network devices such as one or more routers or switches, for example, which are known in the art and thus will not be described herein. This technology has a number of advantages including methods, non-transitory computer readable media, and property transaction systems that facilitate secure real estate transactions on behalf of sellers via immutable non-fungible tokens (NFTs) for properties and smart contracts that increase transparency and transfer property rights to buyers automatically.

In this example, the client devices 104(1)-104(n), property transaction system 102, and blockchain nodes 108(1)-108(n) are disclosed in FIG. 1 as dedicated hardware devices. However, one or more of client devices 104(1)-104(n), property transaction system 102, or blockchain nodes 108(1)-108(n) can also be implemented in software within one or more other devices in the network environment 100. As one example, the property transaction system 102, as well as any of its components or applications, can be implemented as software executing on one of the blockchain nodes 108(1)-108(n), and many other permutations and types of implementations and network topologies can also be used in other examples.

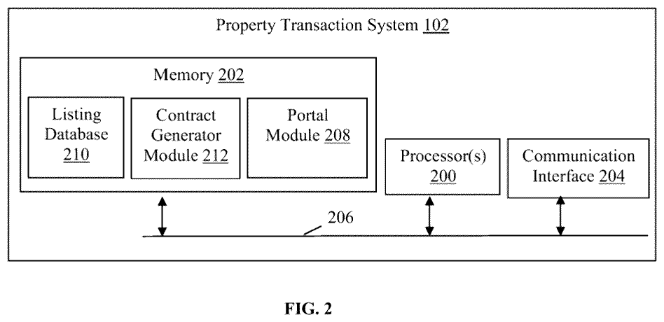

Referring to FIGS. 1-2, the property transaction system 102 may perform any number of functions, including providing GUIs to the client devices 104(1)-104(n) via a broker portal 112 that facilitate presentation of and interaction with property listing data, execution of property ownership transactions, and perform other functions as described and illustrated in detail below. The property transaction system 102 in this example includes processor(s) 200, memory 202, and a communication interface 204, which are coupled together by a bus 206, although the property transaction system 102 can include other types or numbers of elements in other configurations.

The processor(s) 200 of the property transaction system 102 may execute programmed instructions stored in the memory 202 of the property transaction system 102 for any number of the functions described and illustrated herein. The processor(s) 200 may include one or more processing cores, one or more central processing units, and/or one or more graphics processing units, for example, although other types of processor(s) can also be used.

The memory 202 stores these programmed instructions for one or more aspects of the present technology as described and illustrated herein, although some or all of the programmed instructions could be stored elsewhere. A variety of different types of memory storage devices, such as random-access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 can store applications that can include computer executable instructions that, when executed by the processor(s) 200, cause the property transaction system 102 to perform actions, such as to transmit, receive, or otherwise process network messages and requests and generate graphical interfaces and displays, for example, and to perform other actions described and illustrated below. The application(s) can be implemented as components of other applications, operating system extensions, and/or plugins, for example.

Further, the application(s) may be operative in a cloud-based computing environment with access provided via a software-as-a-service (Saas) model. The application(s) can be executed within or as virtual machine(s) or virtual server(s) that may be managed in a cloud-based computing environment. Also, the application(s), and even the property transaction system 102 itself, may be located in virtual server(s) running in a cloud-based computing environment rather than being tied to specific physical network computing devices.

In some examples, the memory 202 includes a portal module 208, a listing database 210, and a contract generator module 212, although other modules can also be used in other examples. The portal module 208 is configured to manage the broker portal by interfacing with the client devices 104(1)-104(n) via the communication network(s) 110 to obtain listing data from property sellers and facilitate property transactions and rights transfers for property buyers. The listing data can be maintained in the listing database 210, which can be a MySQL database, for example, although any other type of database can also be used.

With the property listing data for a particular property from a particular seller of the property, the contract generator module 212 is configured to generate one of the smart contracts 114(1)-114(n), which is deployed within the blockchain network 106. Each of the smart contracts 114(1)-114(n) is configured to automatically transfer an NFT corresponding to a property to one of the wallet applications 116(1)-116(n) (e.g., MetaMask™) associated with a property buyer upon satisfaction of specified conditions. Thus, each of the smart contracts 114(1)-114(n) is a set of executable instructions configured to automatically carry out an action, function, or task in furtherance of a transaction when specified condition(s) are satisfied.

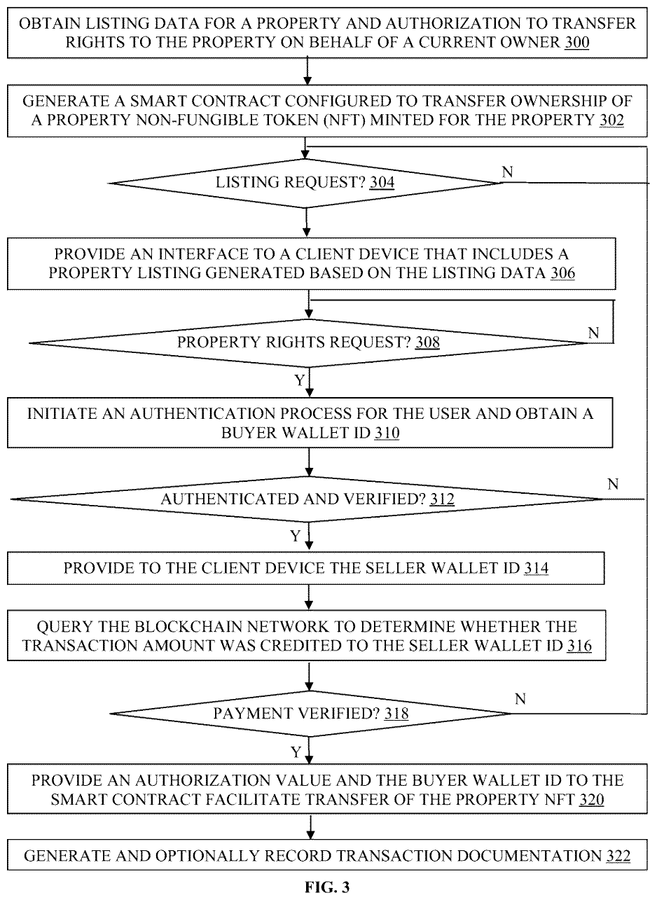

In some examples, one of the conditions requires that a transaction amount was credited to one of the wallet applications 116(1)-116(n) associated with a property seller from one of the wallet applications 116(1)-116(n) corresponding to the property buyer, as recorded on the blockchain network 106. Thus, the wallet applications 116(1)-116(n) can be associated with cryptocurrency wallets in some examples and can have respective addresses on the blockchain network 106. The operations of the broker portal 112 and the contract generator module are described and illustrated in more detail below with reference to FIGS. 3-9.

The communication interface 204 of the property transaction system 102 operatively couples and communicates between the property transaction system 102, client devices 104(1)-104(n), and blockchain nodes 108(1)-109(n), which are coupled together at least in part by the communication network(s) 110 in this particular example, although other types or numbers of communication networks or systems with other types or numbers of connections or configurations to other devices or elements can also be used. The communication network(s) 110 can include wide area network(s) (WAN(s)) and/or local area network(s) (LAN(s)), for example, and can use TCP/IP over Ethernet and industry-standard protocols, although other types or numbers of protocols or communication networks can be used. The communication network(s) 110 can employ any suitable interface mechanisms and network communication technologies including, for example, Ethernet-based Packet Data Networks (PDNs).

The property transaction system 102 in some examples can include a plurality of devices each having one or more processors (each processor with one or more processing cores) that implement one or more steps of this technology. In these examples, one or more of the devices can have a dedicated communication interface and/or memory. Alternatively, one or more of the devices can utilize the memory 202, communication interface 204, and/or other hardware or software components of one or more other devices included in the property transaction system 102. Additionally, one or more of the devices that together comprise the property transaction system 102 in other examples can be standalone devices or integrated with one or more other devices or apparatuses.

Each of the blockchain nodes 108(1)-108(n) of the blockchain network 106 includes a processor coupled to a memory and configured to execute instructions stored in the memory to carry out various tasks as described and illustrated by way of the examples herein. One or more of the blockchain nodes 108(1)-108(n) can be a personal computing device similar to the client devices 104(1)-104(n) or another device, such as a server. The blockchain nodes 108(1)-108(n) can process transactions made on the blockchain network 106 (e.g., trades or payments in cryptocurrency) using the smart contracts 114(1)-114(n) and broker portal 112.

Each of the client devices 104(1)-104(n) of the network environment 100 in this example includes any type of computing device that can exchange network data, such as mobile, desktop, laptop, or tablet computing devices. Each of the client devices 104(1)-104(n) includes processor(s), memory, and a communication interface, which are coupled together by a bus or other communication link (not illustrated), although other numbers or types of components could also be used.

Each of the client devices 104(1)-104(n) may run interface applications, such as web browsers or standalone applications, which may provide an interface to communicate with the property transaction system 102 via the communication network(s) 110. Each of the client devices 104(1)-104(n) may further include a display device, such as a display screen or touchscreen, or an input device, such as a keyboard or mouse, for example (not shown). One or more of the client devices 104(1)-104(n) may be associated with an individual user (e.g., a property buyer or seller), for example.

Although the exemplary network environment 100 with the client devices 104(1)-104(n), property transaction system 102, blockchain nodes 108(1)_108(n), and communication network(s) 110 is described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the client devices 104(1)-104(n), property transaction system 102, or blockchain nodes 108(1)-108(n), for example, may be configured to operate as virtual instances on the same physical machine. In other words, one or more of the client devices 104(1)-104(n), property transaction system 102, or blockchain nodes 108(1)-108(n), may operate on the same physical device rather than as separate devices communicating through the communication network(s) 110. Additionally, there may be more or fewer client devices, property transaction systems, or blockchain nodes than illustrated in FIG. 1.

The examples of this technology may also be embodied as one or more non-transitory computer readable media having instructions stored thereon, such as in the memory 202 of the property transaction system 102, for one or more aspects of the present technology, as described and illustrated by way of the examples herein.

The instructions in some examples include executable code that, when executed by one or more processors, such as the processor(s) 200 of the property transaction system 102, cause the processors to carry out steps necessary to implement the methods of the examples of this technology that will now be described and illustrated herein.

Referring now to FIG. 3, a flowchart of an exemplary method for managing real estate blockchain infrastructure is illustrated. In step 300 in this example, the property transaction system 102 obtains listing data for a property and authorization to transfer rights to the property on behalf of a current owner, also referred to herein as a seller. While the examples described herein relate to a purchase and sale of a property, the rights transferred can correspond to a lease, rental, fractional ownership, or any other transferable property rights. Thus, the listing data and the authorization to transfer the property rights can be received via an interface provided to a user of one of the client devices 104(1)-104(n) that is a current owner or other holder of the transferable property rights.

The listing data in some examples can include property images, description, location, or any other information regarding the property, along with a transaction amount (e.g., sale or asking price). Optionally, the authorization received in step 300 can be in the form of authorization data that can include an authorization value (e.g., a unique key or token) that is shared with the property transaction system 102 via a cryptographic or encrypted exchange, although other types of authorizations can also be received from the seller using one of the client devices 104(1)-104(n).

The authorization data can also include an identifier (ID) for a wallet on the blockchain network 106 associated with the seller of the property and/or an NFT ID for an NFT minted on the blockchain network 106 for the property associated with the received listing data, and the authorization data can include other information in other examples. With the seller wallet ID, the property transaction system 102 can act as a broker with respect to the property based on the property NFT corresponding to the NFT ID as described and illustrated below.

In step 302, the property transaction system 102 generates a smart contract 114 configured to transfer ownership of the property NFT. The property NFT could have been previously minted by the seller, the property transaction system in step 300, or a governmental agency, for example, although other methods for issuing the property NFT on the blockchain network 106 could also be used in other examples. The property NFT is a unique representation of the property on the blockchain network 106 whose ownership is recorded on the blockchain network 106, such as based on an association with an ID of a wallet on the blockchain network 106 (e.g., the seller wallet ID included in the received authorization data).

The smart contract 114 is configured to automatically transfer ownership of the NFT to another wallet ID on the blockchain network 106 upon satisfaction of one or more conditions and is therefore generated based on, and includes an indication of, the property NFT ID. The conditions in this example include providing an authorization (e.g., the authorization value received with the authorization data) to prove that the seller authorized the entity (e.g., property transaction system 102) requesting the property NFT transfer. The conditions also can include verification from the property transaction system 102, or via a polling or other automated manner, that the transaction amount was paid (e.g., credited to the seller wallet ID). Any other types or number of conditions can also be specified in the smart contract 114 in other examples.

In step 304, the property transaction system 102 determines whether a listing request has been received from one of the client devices 1004(1)-104(n) associated with a user that is a prospective buyer of the property. The listing request can be received via a website or other interface provided by the property transaction system 102 in furtherance of a brokerage service provided by the property transaction system 102. If the property transaction system 102 determines that a listing request has not been received, then the No branch is taken back to step 304 and the property transaction system 102 effectively waits for a listing request to be received. In other examples, the No branch can be taken back to step 300 and steps 300-302 can be repeated in parallel with one or more of steps 304-322 for any number of properties. However, if the property transaction system 102 determines in step 304 that a listing request has been received, then the Yes branch is taken to step 306.

In step 306, the property transaction system 102 provides an interface to one of the client devices 104(1)-104(n) from which the listing request originated. The interface can include a property listing generated based on the listing data received in step 300 for any number of properties.

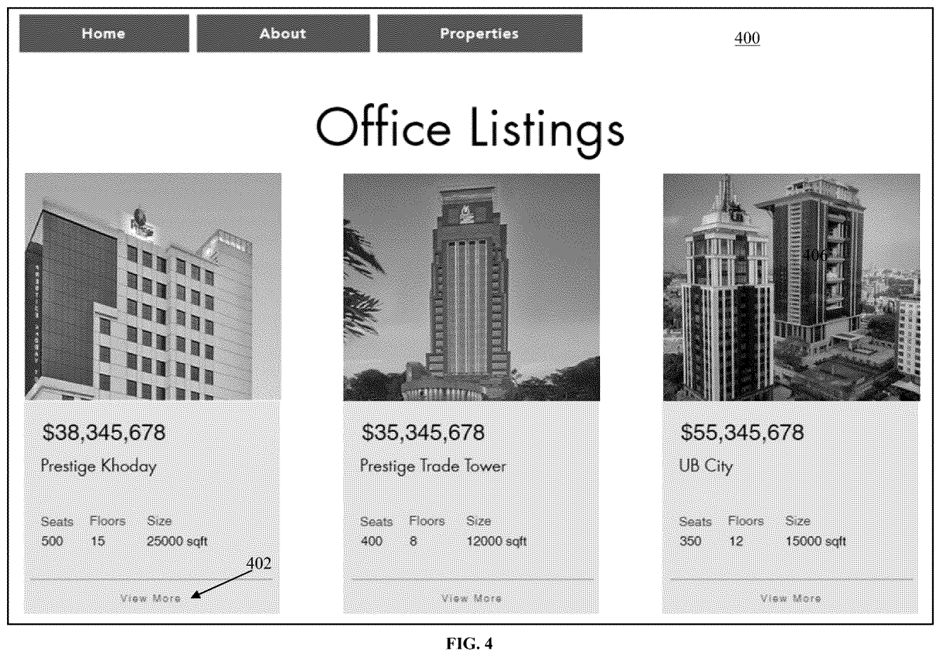

Referring to FIG. 4, a screenshot of an exemplary property listing interface 400 for a plurality of properties offered for sale is illustrated. Thus, the property listing interface 400 can be generated by the property transaction system 102 and provided to one of the client devices 104(1)-104(n) upon request. In this example, the property listing interface 400 includes a portion of obtained property listing data for three properties, which represent office listings for which a host of the property transaction system 102 is acting as a broker.

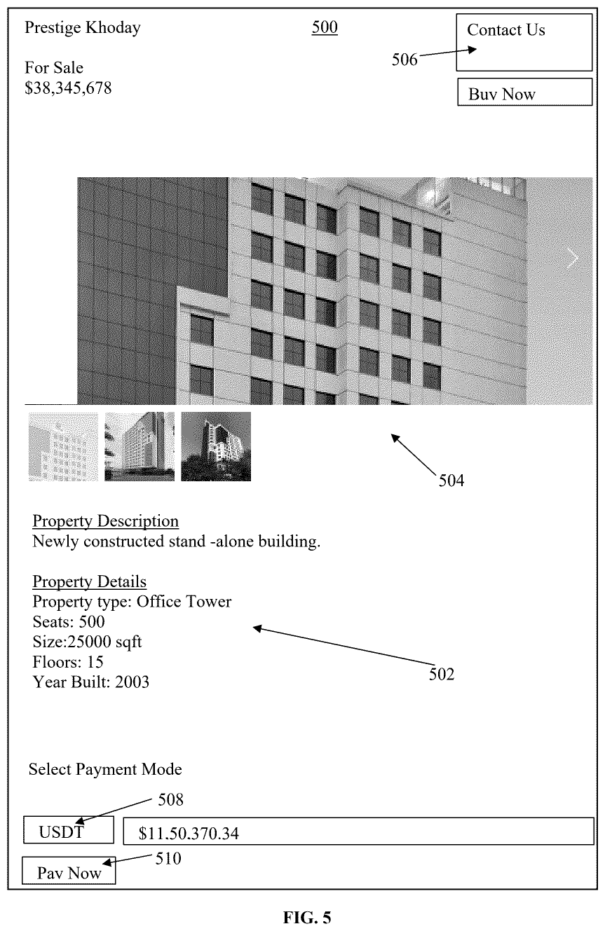

More specifically, the portion of the listing data includes a name of the building, number of seats, number of floors, building size, and the transaction amount representing a listing price for purchase of the property. The property listing interface 400 also includes an expansion link 402 that allows a user to generate another interface that includes additional property listing data for the associated property and facilitates a purchase of the property, which is explained below with reference to FIG. 5.

Referring back to FIG. 3, in step 308, the property transaction system 102 determines whether a property rights request has been received, such as from the one of the client devices 104(1)-104(n) from which the listing request was received in step 304, for example. The property rights request can be a request to obtain the property rights offered via the property listing interface 400. For example, the property rights request can be a property purchase request, although other types of property rights requests can be received in step 308 in other examples.

Referring to FIG. 5, a screenshot of an exemplary property purchase interface 500 for a particular property is illustrated. In this particular example, the property purchase interface 500 is generated and provided by the property transaction system 102 in response to selection of the expansion link 402. The property purchase interface 500 includes an expanded property description 502 and the property details from the property listing interface 400 and the property listing data for the associated property. The property purchase interface 500 also includes a plurality of images 504 associated with the property and a contact us link 506 that facilitates communication between prospective buyers and the broker host of the property transaction system 102.

In this example, the property purchase interface 500 also includes a menu 508 for a payment type (e.g., USD, Ethereum tokens (ETH), or Bitcoin), which can be restricted or defined by a seller in the property listing data, for example. Below the menu 508, the property purchase interface 500 includes a pay now button 510 that, when selected by a user of one of the client devices 104(1)-104(n), triggers the property rights request received in step 308 in this example. Other types of information can be included on the property purchase interface 500 and the property rights request can also be facilitated and/or generated in other ways in other examples.

Referring back to FIG. 3, if the property transaction system 102 determines in step 308 that a property rights request has not been received, then the No branch is taken back to step 308 and the property transaction system 102 effectively waits for a property rights request to be received. However, if the property transaction system 102 determines that a property rights request has been received, then the yes branch is taken to step 310.

In step 310, the property transaction system 102 initiates an authentication process for the user of the one of the client devices 104(1)-104(n) from which the property rights request originated and obtains an ID of a wallet of the buyer on the blockchain network 106. The authentication process can be a know-your-customer (KYC) compliant process, for example, and can also be facilitated by a third-party service provider hosting a web server coupled to the communication network(s) 110, for example. Additionally, the buyer wallet ID can be obtained via a provided interface.

While in this example the buyer wallet ID and the seller wallet ID are on the same blockchain network 106 as the property NFT and the smart contract 114, the various blockchain networks can be different in other examples. For example, the property NFT can be maintained on an Ethereum blockchain network hosted by a government agency whereas the seller and/or buyer wallet ID(s) can be associated with wallets that are only capable of interaction with the Bitcoin network.

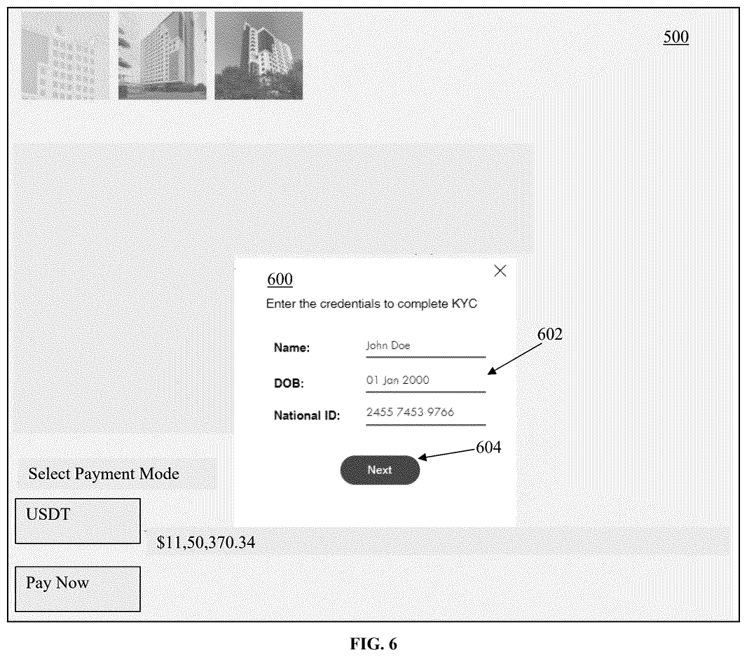

Referring to FIG. 6, a screenshot of an exemplary authentication overlay 600 is illustrated. The authentication overlay 600 in this example includes an authentication form 602 for input of a name, date of birth (DOB) and a national ID (e.g., social security number), although any other type of information can also be obtained to authenticate the user in other examples. Optionally, another input field can be provided on the authentication form 602 for a wallet ID of the user, which in this example is a purchaser of the property, although the buyer wallet ID can be obtained in other ways in other examples.

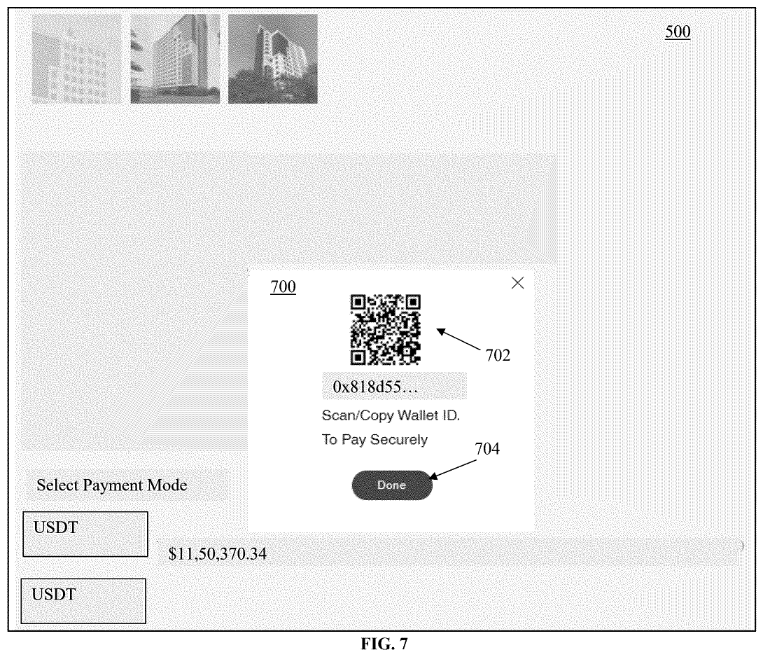

Additionally, the authentication overlay 600 includes a selectable indication 604 (e.g., a next button) that, when selected by a user of one of the client devices 104(1)-104(n) facilitates an exchange of wallet ID information to facilitate payment for the property, as explained in more detail below with reference to FIG. 7. While an authentication input form is illustrated as an authentication overlay 600 in this example, the authentication input form can be a new web page, other type of graphical interface, and/or facilitated by a third-party device in other examples.

Referring back to FIG. 3, in step 312, the property transaction system 102 determines whether the buyer user of the one of the client devices 104(1)-104(n) is authenticated as a result of the authentication process of step 31. Optionally, whether the provided buyer wallet ID is verified (e.g., as being associated with, owned, or controlled by the buyer).

The buyer wallet ID can be verified by correlated data provided by a cryptocurrency exchange associated with the buyer wallet ID with the personal information within the authentication data obtained for the buyer, for example. Other checks can also be performed, such as whether the buyer wallet ID has sufficient funds for the transaction, for example. If the property transaction system 102 determines that the buyer is not authenticated, and/or the buyer wallet ID is not verified, then the No branch is taken back to step 304 and the property rights request is denied. However, if the property transaction system 102 determines that the buyer is authenticated, and the buyer wallet ID is verified, then the Yes branch is taken to step 314.

In step 314, the property transaction system 102 provides the seller wallet ID to the one of the client devices 104(1)-104(n) associated with the authenticated buyer and verified buyer wallet ID. The seller wallet ID could have been obtained with the listing data in step 300, for example, although the seller wallet ID can be obtained in other ways in other examples. Additionally, the seller wallet ID can be provided via an update to the interface previously provided to the one of the client devices 104(1)-104(n).

Referring to FIG. 7 is a screenshot of an exemplary seller wallet overlay 700 is illustrated. In this example, the seller wallet overlay 700 is provided via an update to the provided interface triggered by selection of the selectable indication 604 of the authentication overlay 600. While seller wallet ID is illustrated as a seller wallet overlay 700 in this example, the seller wallet ID can be a new web page, other type of graphical interface, and/or a message provided to the one of the client devices 104(1)-104(n) in other examples.

The seller wallet overlay 700 includes a two-dimensional barcode 702 that, when captured by an imaging device of the one of the client devices 104(1)-104(n) causes one of the wallet applications 116(1)-116(n) executing on the one of the client devices 104(1)-104(n) to populate an interface to facilitate a payment to the seller wallet ID, although other methods for facilitating payment and communicating the seller wallet ID can be used in other examples. The seller wallet overlay 700 also includes a done button 704 in this example that, when selected by the buyer using the one of the client devices 104(1)-104(n) triggers an indication or message to the property transaction system 102 that the buyer has submitted the payment corresponding to the transaction amount.

Referring back to FIG. 3, in step 316, the property transaction system 102 queries the blockchain network 106 to determine whether the transaction amount was credited to the seller wallet ID from the buyer wallet ID. As explained above, the transaction amount can be paid in a cryptocurrency corresponding to a blockchain network that is different than the blockchain network 106 on which the property NFT is hosted. While the property transaction system 102 queries the blockchain network 106 to verify that the payment was made, other verification methods can be used in other examples.

In yet other examples, the smart contract 114 can be generated in step 302 as configured to monitor the seller wallet ID on the blockchain network 106 for a payment corresponding to the transaction amount and/or having other associated metadata (e.g., an indication of the NFT ID). In these examples, the smart contract can automatically verify the payment and transfer the property NFT without requiring the property transaction system 102 to query the blockchain network 106 in step 316 to perform step 320.

However, with reference to the particular example of FIG. 3, if the property transaction system 102 determines in step 318 that the payment is not verified (e.g., within a defined time period subsequent to providing the seller wallet ID in step 314) based on the query in step 316, then the No branch is taken to step 304 and the property rights request is denied. Alternatively, if the property transaction system 102 determines that the payment is verified then the Yes branch is taken to step 320.

In step 320, the property transaction system 102 provides the authorization value received in step 300 and the buyer wallet ID to the smart contract 114 to facilitate transfer of the property NFT to the buyer wallet ID. While the authorization value is used in this example to prove that the broker host of the property transaction system 102 was authorized by the property seller to transfer rights in the property on the seller's behalf, other methods can be used in other examples to satisfy an authorization condition of the smart contract 114. While the same buyer wallet ID is used in this example as the source of the funds corresponding to the transaction amount and the destination for the property NFT, different buyer wallet IDs can also be used in other examples.

Thus, the providing of the authorization value and the buyer wallet ID in this example satisfy the conditions of the smart contract 114 generated in step 302, although other conditions can also be included in the smart contract 114 in other examples. The automated transfer of the property NFT to the buyer wallet ID will be a transaction automatically recorded on the blockchain network 106 and available for public inspection thereby advantageously reducing the possibility of a fraudulent property transfer.

In step 322, the property transaction system 102 optionally generates and/or records transaction documentation relating to the transfer of the property from the seller to the buyer. The smart contract 114 can be configured to initiate generation, updating, or recordation of any collateral documents (e.g., title deed) within the blockchain network 106. In other examples, the property transaction system 102 can automatically generate any documentation required by governmental agencies, insurance providers, or any other third-party entity, based on the listing details and/or information requested of the buyer (e.g., during the authentication process of step 310).

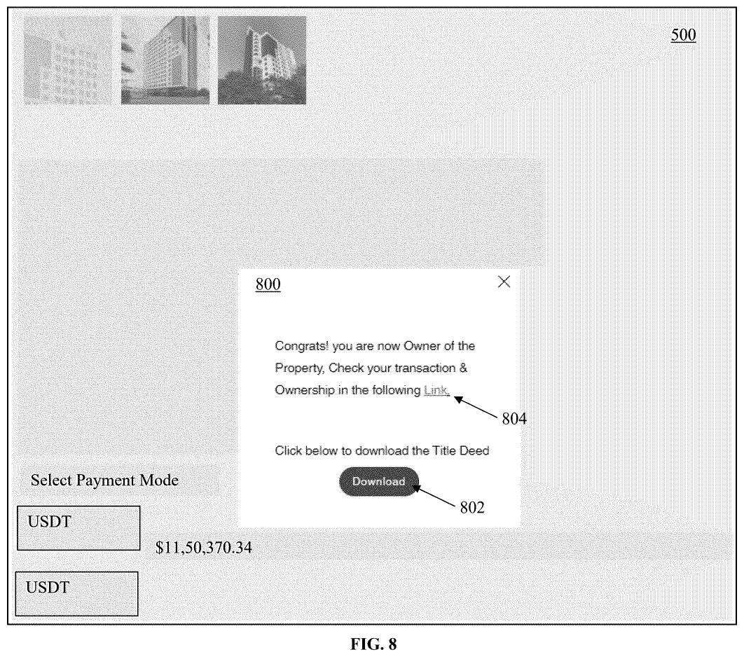

Referring to FIG. 8, a screenshot of an exemplary transaction success overlay 800 is illustrated. After verifying the payment in step 318, the property transaction system 102 optionally updates the interface provided to the one of the client devices 104(1)-104(n) associated with the buyer to display the transaction success overlay 800 to indicate that the transaction was successful and that the property NFT is now linked to the buyer wallet ID. In this example, the transaction success overlay 800 includes a download button 802 that allows the buyer to download the documentation that may be automatically generated in step 322. Additionally, the transaction success overlay 800 includes a link 804 to transaction details.

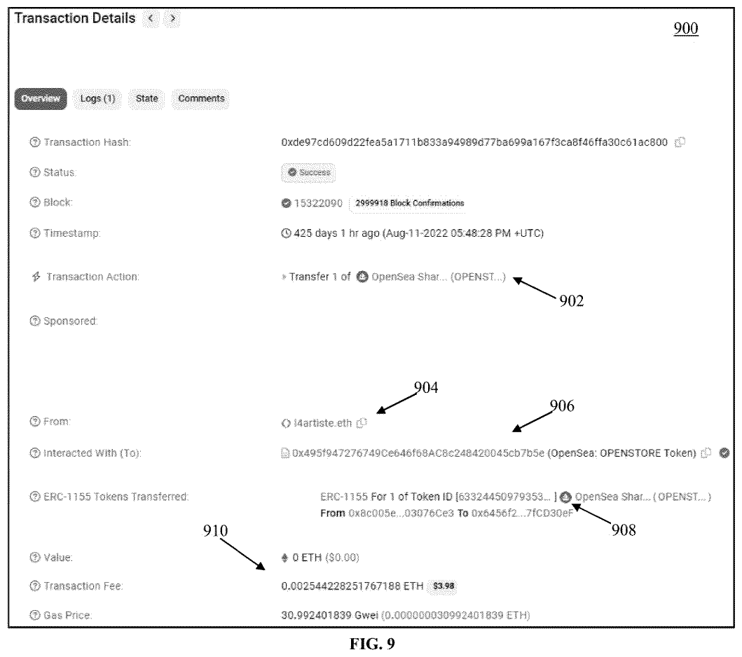

Referring to FIG. 9, a screenshot of an exemplary blockchain transaction detail interface 900 is illustrated. The blockchain transaction detail interface 900 can be provided by the property transaction system 102 or a third-party device upon selection by the user of the one of the client devices 104(1)-104(n) of the download button 802. The blockchain transaction detail interface 900 can be populate with information previously recorded on the blockchain network 106 (e.g., by the executed smart contract 114).

For example, the blockchain transaction detail interface 900 can include a transaction type 902 (e.g., purchase or lease), a seller identity 904, a buyer identity 906, buyer and seller wallet IDs 908, and monetary values 910 associated with the transaction (e.g., transaction value, transaction fee/amount, and gas fee for the blockchain transaction). Other information, including any documentation generated and recorded on the blockchain network 106 that is associated with the property transfer, can also be included on, or linked by, the blockchain transaction detail interface 900.

Accordingly, as described and illustrated by way of the examples herein, this technology more efficiently facilitates property rights transfers and transactions via blockchain networks using particular authorization values and smart contracts. The recordation of transaction details on a blockchain network allows for public inspection, more efficient searching of property details and ownership history, reduced fraud, and quicker property transfers. Thus, fewer computing and other resources are required in order to facilitate a transfer of property rights with this technology.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A method for managing blockchain infrastructure to improve security of physical asset ownership transfers, the method implemented by a property transaction system and comprising:
receiving, via one or more communication networks, authorization data from a first client device of a seller of a physical asset, wherein the authorization data comprises a first wallet identifier (ID) for the seller;
generating, via the one or more communication networks, using one or more blockchain nodes, after receipt of the authorization data, and on a first blockchain network comprising the one or more blockchain nodes, a smart contract configured to automatically transfer ownership of a non-fungible token (NFT) upon satisfaction of one or more conditions. wherein the NFT comprises a unique representation for the physical asset on the first blockchain network and the ownership of the physical asset is recorded on the first blockchain network based on an association of the NFT with the first wallet ID;
receiving, from a graphical user interface (GUI) provided via the one or more communication networks, a request to obtain rights in the physical asset from a second client device of a buyer, wherein the request comprise s a second wallet ID for the buyer;
authenticating the buyer in response to the request, comprising:
obtaining, via the one or more communication networks and from a cryptocurrency exchange, exchange data using the second wallet ID; and
correlating the exchange data with personal information included in authentication data for the buyer obtained via an authentication form provided to the second client device via the one or more communication networks;
updating the GUI via the one or more communication networks to provide the first wallet ID to the second client device in response to the request and after the authentication;
querying via the one or more communication networks a second blockchain network to determine that a transaction amount was credited to the first wallet ID from the second wallet ID; and
providing, via the one or more communication networks and the one or more blockchain nodes of the first blockchain network, the second wallet ID to the smart contract to cause a transfer of the NFT to the second wallet ID and recordation of an ownership transfer of the physical asset on the first blockchain network.

2. The method of claim 1, wherein the authorization data further comprises an authorization value and the method further comprises providing the authorization value to the smart contract with the second wallet ID to satisfy at least one of the conditions.

3. The method of claim 1, wherein the authorization data further comprises an NFT ID for the NFT and the method further comprises generating the smart contract further based on the NFT ID.

4. The method of claim 1, wherein the GUI comprises listing data, comprising a plurality of property details for a property and the transaction amount, and a selectable indication associated with the property and selection of the selectable indication by a user of the second client device triggers the request and the update of the GUI to include the first wallet ID.

5. The method of claim 1, wherein the ownership transfer corresponds to a purchase or lease of at least a portion of a property and the method further comprises automatically generating and recording on the blockchain network transaction documentation including contractual terms associated with the ownership transfer of the property.

6. The method of claim 1, wherein the first and second wallet IDs are associated with the second blockchain network, the transaction amount comprises a cryptocurrency corresponding to the second blockchain network, and the first blockchain network is associated with a different cryptocurrency protocol than the second blockchain network.

7. A transaction system, comprising memory having instructions stored thereon for managing blockchain infrastructure to improve security of physical asset ownership transfers and one or more processors coupled to the memory and configured to execute the stored instructions to:
receive, via one or more communication networks, authorization data from a first client device of a seller of a physical asset, wherein the authorization data comprises a first wallet identifier (ID) for the seller;
generate, via the one or more communication networks, using one or more blockchain nodes, after receipt of the authorization data, and on a first blockchain network comprising the one or more blockchain nodes, a smart contract configured to automatically transfer ownership of a non-fungible token (NFT) upon satisfaction of one or more conditions, wherein the NFT comprises a unique representation for the physical asset on the first blockchain network and the ownership of the physical asset is recorded on the first blockchain network based on an association of the NFT with the first wallet ID;
receive, from a graphical user interface (GUI) provided via the one or more communication networks, a request to obtain rights in the physical asset from a second client device of a buyer;
authenticate the buyer in response to the request, comprising:
obtaining, via the one or more communication networks and from a cryptocurrency exchange, exchange data using the second wallet ID; and
correlating the exchange data with personal information included in authentication data for the buyer obtained via an authentication form provided to the second client device via the one or more communication networks;
update the GUI via the one or more communication networks to provide the first wallet ID to the second client device in response to the request and after the authentication;
query via the one or more communication networks a second blockchain network to determine that a transaction amount was credited to the first wallet ID from the second wallet ID; and
provide, via the one or more communication networks and the one or more blockchain nodes of the first blockchain network, the second wallet ID to the smart contract to cause a transfer of the NFT to the second wallet ID and recordation of an ownership transfer of the physical asset on the first blockchain network.

8. The transaction system of claim 7, wherein the authorization data further comprises an authorization value and the processors are further configured to execute the stored instructions to provide the authorization value to the smart contract with the second wallet ID to satisfy at least one of the conditions.

9. The transaction system of claim 7, wherein the authorization data further comprises an NFT ID for the NFT and the processors are further configured to execute the stored instructions to generate the smart contract further based on the NFT ID.

10. The transaction system of claim 7, wherein the GUI comprises listing data, comprising a plurality of property details for a property and the transaction amount, and a selectable indication associated with the property and selection of the selectable indication by a user of the second client device triggers the request and the update of the GUI to include the first wallet ID.

11. The transaction system of claim 7, wherein the ownership transfer corresponds to a purchase or lease of at least a portion of a property and the processors are further configured to execute the stored instructions to automatically generate and record on the blockchain network transaction documentation including contractual terms associated with the ownership transfer of the property.

12. The transaction system of claim 7, wherein the first and second wallet IDs are associated with the second blockchain network, the transaction amount comprises a cryptocurrency corresponding to the second blockchain network, and the first blockchain network is associated with a different cryptocurrency protocol than the second blockchain network.

13. A non-transitory computer readable medium having stored thereon instructions for managing blockchain infrastructure to improve security of physical asset ownership transfers, comprising executable code that, when executed by one or more processors, causes the processors to:
receive, via one or more communication networks, authorization data from a first client device of a seller of a physical asset, wherein the authorization data comprises a first wallet identifier (ID) for the seller;
generate, via the one or more communication networks, using one or more blockchain nodes, after receipt of the authorization data, and on a first blockchain network comprising the one or more blockchain nodes, a smart contract configured to automatically transfer ownership of a non-fungible token (NFT) upon satisfaction of one or more conditions, wherein the NFT comprises a unique representation for the physical asset on the first blockchain network and the ownership of the physical asset is recorded on the first blockchain network based on an association of the NFT with the first wallet ID;
receive, from a graphical user interface (GUI) provided via the one or more communication networks, a request to obtain rights in the physical asset from a second client device of a buyer;
authenticate the buyer in response to the request, comprising:
obtaining, via the one or more communication networks and from a cryptocurrency exchange, exchange data using the second wallet ID; and
correlating the exchange data with personal information included in authentication data for the buyer obtained via an authentication form provided to the second client device via the one or more communication networks;
update the GUI via the one or more communication networks to provide the first wallet ID to the second client device in response to the request and after the authentication;
query via the one or more communication networks a second blockchain network to determine that a transaction amount was credited to the first wallet ID from the second wallet ID; and
provide, via the one or more communication networks and the one or more blockchain nodes of the first blockchain network, the second wallet ID to the smart contract to cause a transfer of the NFT to the second wallet ID and recordation of an ownership transfer of the physical asset on the first blockchain network.

14. The non-transitory computer readable medium of claim 13, wherein the authorization data further comprises an authorization value and the executable code, when executed by the processors, further causes the processors to provide the authorization value to the smart contract with the second wallet ID to satisfy at least one of the conditions.

15. The non-transitory computer readable medium of claim 13, wherein the authorization data further comprises an NFT ID for the NFT and the executable code, when executed by the processors, further causes the processors to generate the smart contract further based on the NFT ID.

16. The non-transitory computer readable medium of claim 13, wherein the GUI comprises listing data, comprising a plurality of property details for a property and the transaction amount, and a selectable indication associated with the property and selection of the selectable indication by a user of the second client device triggers the request and the update of the GUI to include the first wallet ID.

17. The non-transitory computer readable medium of claim 13, wherein the ownership transfer corresponds to a purchase or lease of at least a portion of a property and the executable code, when executed by the processors, further causes the processors to automatically generate and record on the blockchain network transaction documentation including contractual terms associated with the ownership transfer of the property.

18. The non-transitory computer readable medium of claim 13, wherein the first and second wallet IDs are associated with the second blockchain network, the transaction amount comprises a cryptocurrency corresponding to the second blockchain network, and the first blockchain network is associated with a different cryptocurrency protocol than the second blockchain network.
